(19) United States
(12) Patent Application Publication
(10) Pub. No.: US 2013/0283753 A1
(43) Pub. Date: Oct. 31, 2013

(54) Dual Head Hand Rake Assembly

(71) Applicant: RGS Golf Management, Inc., (US)

(72) Inventors: Robert W. Sturges, Urbana, MD (US); Ray D. Thomas, Melbourne (AU)

(73) Assignee: RGS GOLF MANAGEMENT, INC., Urbana, MD (US)

(21) Appl. No.: 13/661,144

(22) Filed: Oct. 26, 2012

Related U.S. Application Data
(60) Provisional application No. 61/551,482, filed on Oct. 26, 2011.

(51) Int. Cl. A01D 7/00

(52) U.S. Cl. CPC A01D 7/00
USPC 56/400.16

(57) ABSTRACT

A hand rake assembly includes a single elongated handle joined to two side-by-side rake head of the type wherein the tines are arranged in a fan pattern and are bent at their distal ends to form rake fingers disposed in a common plane with tips in a linear array. The plane of the fingers is common to both rake heads and the tips of the fingers reside along the same straight line and are uniformly spaced. In one embodiment a Y-shaped connector permits the handle and rake stems to be engaged and disengaged by actuation of a single screw.

### CROSS REFERENCE TO RELATED APPLICATIONS

The present application is a nonprovisional application of U.S. Provisional Application No. 61/551,482, entitled “Hand Rake Assembly and Connector” and filed Oct. 26, 2011, the disclosure of which is hereby incorporated by reference in its entirety.

### FIELD OF THE INVENTION

The present invention in one aspect pertains to hand rake assemblies having plural rake heads suitable for general raking utility and having particular applicability for raking sand traps on golf courses. Another aspect the invention pertains to a unique connector for joining the ends of three elongated members such as rods, tubes or the like, and having particular utility in the aforementioned hand rake assembly.

### BACKGROUND OF THE INVENTION

Typical sand or garden rakes have an elongated handle joined to a rake head at the center of a width-wise extending row of teeth. The rake head width is limited by the ability of the user to readily manipulate the head, particularly in response to uneven yaw forces experienced during a raking stroke on uneven terrain. Accordingly, rake heads typically have a maximum practical width on the order of twenty-four inches, and this defines or limits the swath of each rake stroke and the time required to complete a raking job. It is desirable, therefore, to provide a hand rake assembly capable of a greater swath per stroke without adversely affecting the user's control of rake strokes

It is known to join two rakes that are pulled by a tractor or other vehicle in a manner such that the rows of teeth of the two rake heads are aligned transversely of the pull direction to thereby double the raking swath of the assembly. Such assemblies, although satisfactory for tractor driven raking, are typically too heavy and complex to be useful for hand raking.

Moreover, the connections for the two rakes are complex, and even the simplest connection requires individual attachment at three separate connector joints, one for each rake and one for the pull rod attached to the vehicle. It is desirable to provide an improved connector that permits two rakes and a pull member to be joined quickly and simply.

### SUMMARY OF THE INVENTION

According to one aspect of the present invention a hand rake assembly comprises an elongated handle in the form of a rod having proximal and distal ends. first and second rake heads each include a fan-like pattern of multiple flexible elongated tines having bent distal tine ends defining rake fingers oriented in respective arrays of side-by-side coplanar rake fingers. A joining member secures the distal handle end to the rake units such that the rake heads are in co-planar side-by-side adjacency with the arrays of rake fingers disposed in a common plane.

In accordance with another aspect of the invention, in order to impart stability to the assembly, the joining member is a general U-shaped bar having a base and first and second legs extending from the base. The base is secured to the distal handle end and each of the first and second legs has a distal leg end secured to the first and second rake heads, respectively.

In accordance with an alternative stability-imparting embodiment, each rake unit includes a rake stem having a distal stem end joined to the rake head and a proximal stem end. The stem distal end is secured to and extends perpendicularly from the rake head. An intermediate stem portion includes a bend in the range of approximately 45° and 60°. The joining member comprises a generally Y-shaped connector secured to the distal end of the handle, and the proximal ends of the stems and permits it to rapidly engage and disengage the handle and stems.

### BRIEF DESCRIPTION OF THE DRAWINGS

FIG. 1 is a view in perspective of a first embodiment of a rake assembly according to the present invention.

FIG. 2 is a front view in elevation of the assembly of FIG. 1.

FIG. 3 is a rear view in elevation of the assembly of FIG. 1.

FIG. 4 is a right side view in elevation of the assembly of FIG. 1.

FIG. 5 is a left side view in elevation of the assembly of FIG. 1.

FIG. 6 is a top view in plan of the assembly of FIG. 1.

FIG. 7 is a bottom view in plan of the assembly of FIG. 1.

FIG. 8 is an exploded view in perspective illustrating the manner of assembling the components of the assembly of FIG. 1.

FIG. 9 is a view in perspective of a connector used to join the components of a second embodiment of a rake assembly illustrated in FIG. 11.

FIG. 10 is an exploded view in elevation of the connector of FIG. 10 illustrating the manner of assembling the components of the embodiment of FIG. 11.

FIG. 11 is a front view in perspective of the second embodiment of a rake assembly.

### DETAILED DESCRIPTION OF THE INVENTION

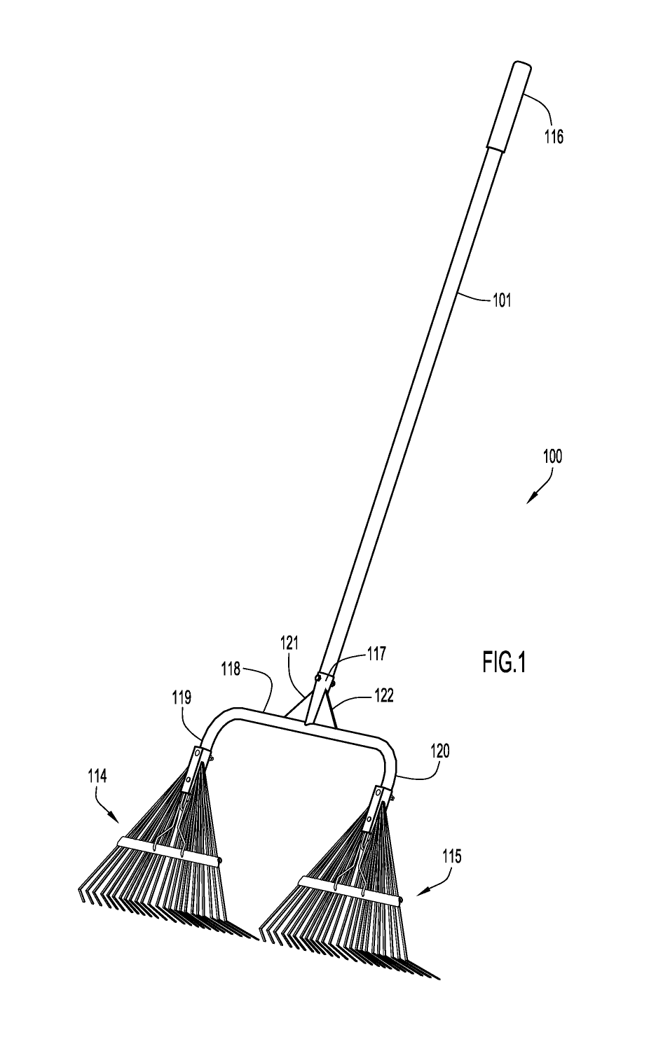

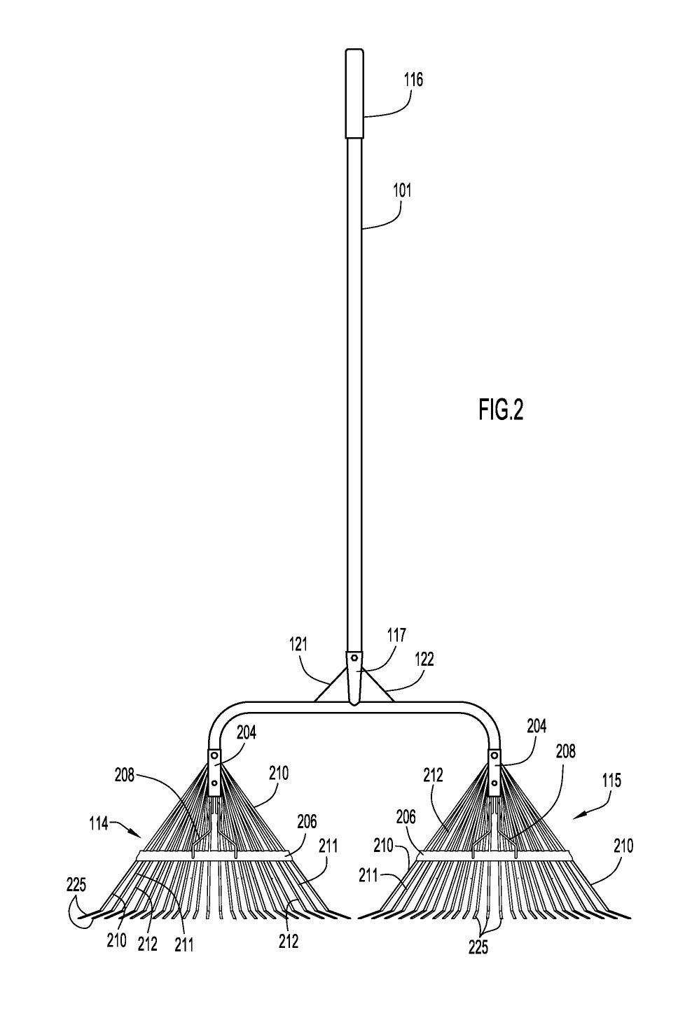

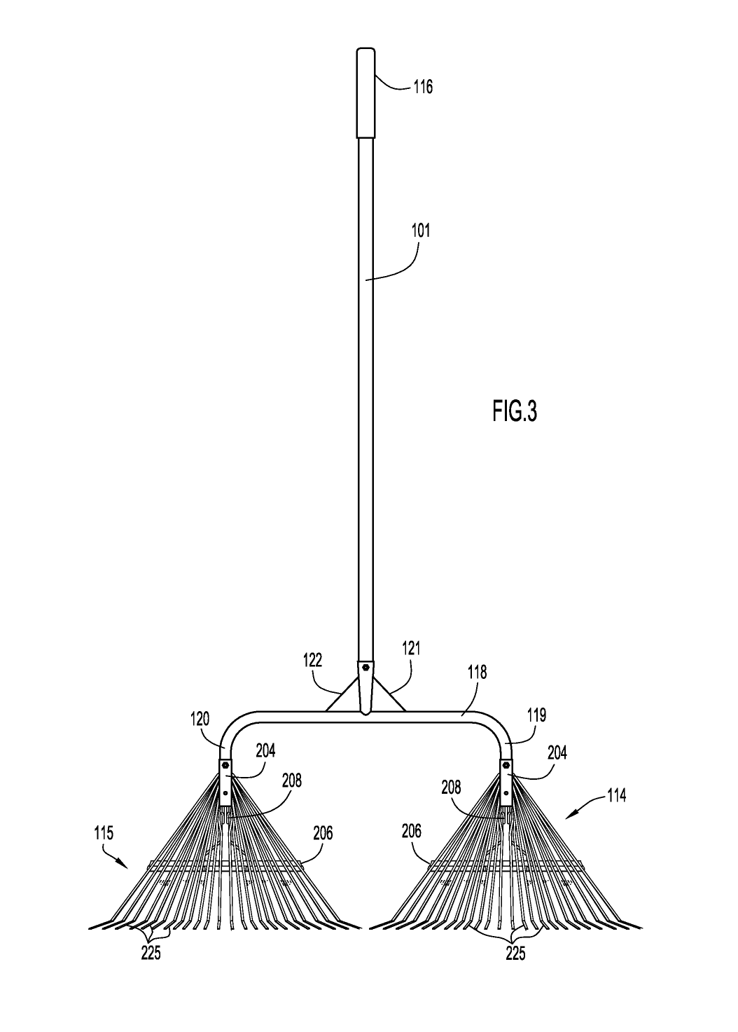

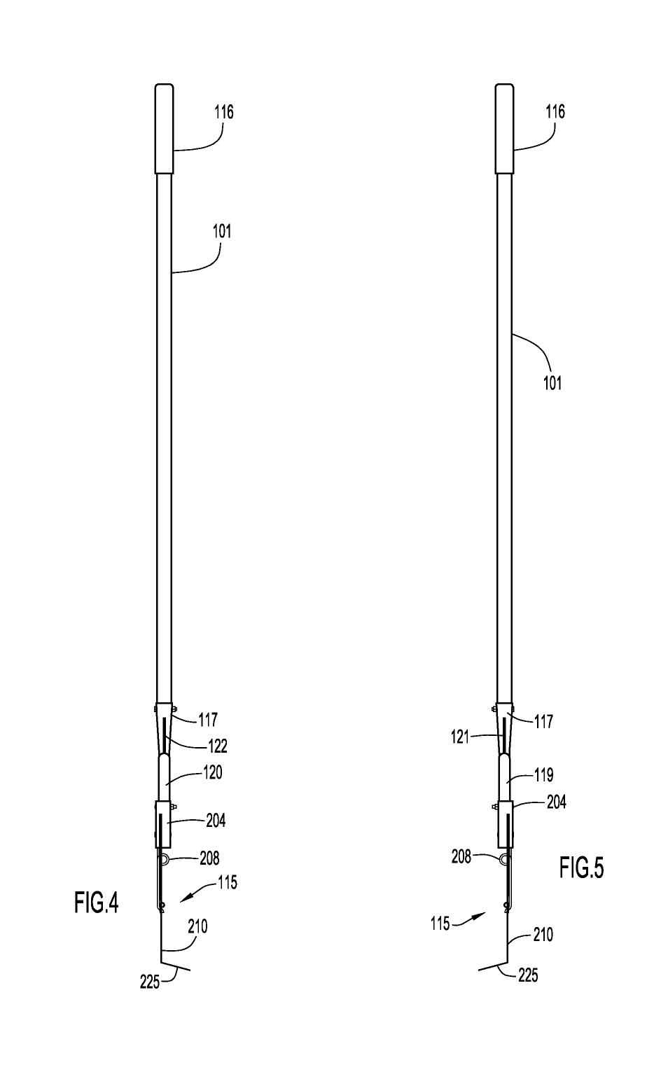

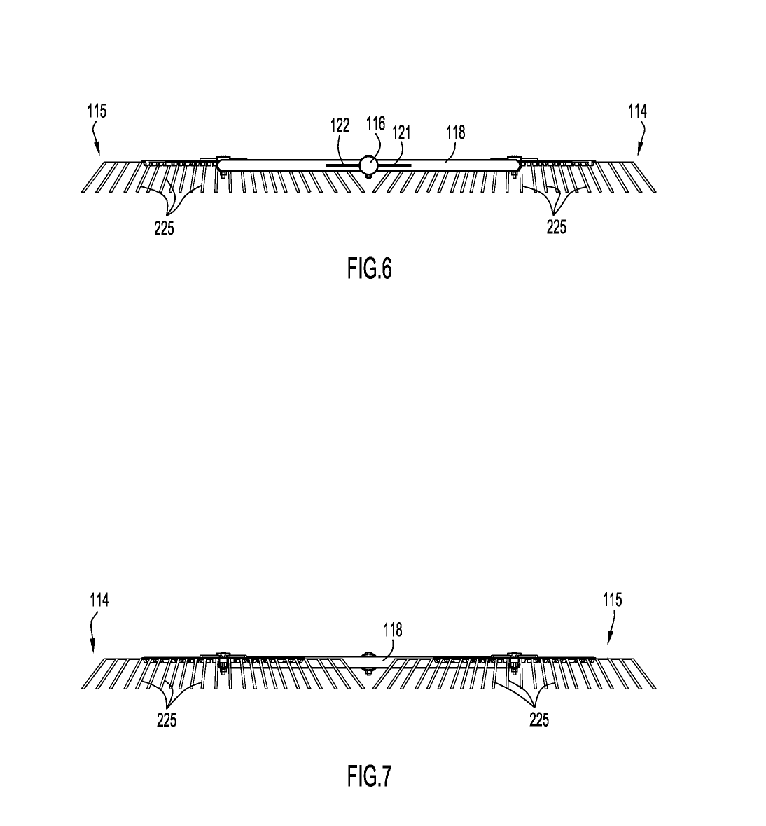

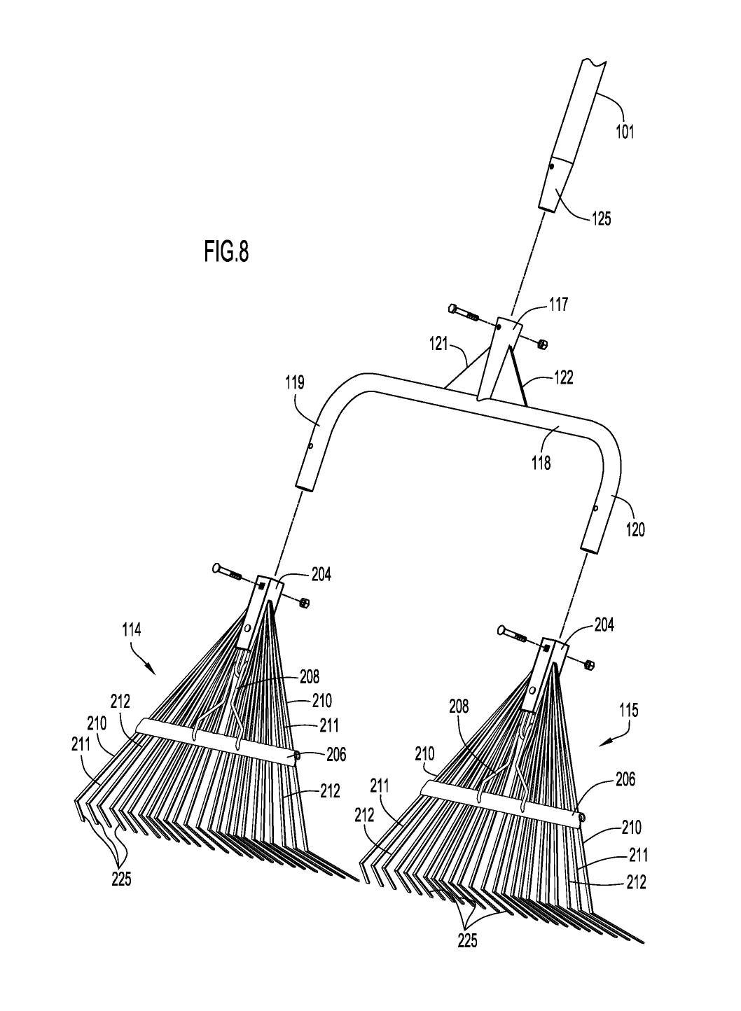

Referring to FIGS. 1 through 8, a hand rake assembly 100 according includes a handle 101 in the form of an elongated hollow tube having a proximal end that is axially inserted into a closed ended hollow cylindrical grip 116. The distal end of the handle is tapered and secured in an open ended hollow socket member 117 forming part of the joining structure between the handle and the rake heads.

The joining structure includes a generally U-shaped joining bar having a relatively long base portion 118 terminating in two relatively short perpendicularly extending arms 119 and 120 that support respective rake heads 114 and 115 extending generally distally from their distal ends. Socket member 117 is disposed centrally between arms 119 and 120 on the proximally facing side of base portion 118 and is sturdily secured to the base portion by right triangular gussets 121 and 122 disposed on opposite sides of the socket. Each gusset is welded along one edge to base portion 118 and along a perpendicular edge to the socket.

The distally tapered distal end 125 of handle 101 fits into a similarly tapered interior bore of socket member 117, preferably in a friction fit engagement. In addition, tapered distal end 125 has a pair of diametrically aligned through holes defined therein arranged to be rotationally aligned with similarly diametrically aligned through holes defined in socket 117 member when distal end 125 is fully inserted in the socket. With the through holes in distal end 125 rotationally aligned with the through holes in socket member 117 an engagement screw is inserted transversely through the handle and socket and secured in by a nut to lock the engagement between the handle and socket member.

Rake heads 114 and 115 are of the general type disclosed in U.S. Pat. No. 7,891,162 (Liao) the entire disclosure form which is incorporated herein by reference. Specifically, the rake heads 114 and 115 are substantially identical and each comprises a plurality of dual tine members 210, 211, 212, etc. that are attached to a socket 204 and are supported by a cross brace 206 and a U-shaped spring member 208. The dual tine members are made from flat spring metal stock and have a generally V-shaped configuration with a rounded vertex from which two resilient tine sections diverge from one another in a distal direction. The dual tine members vary in overall length and are arranged in groups. In this manner the tine members define a fan pattern that diverges distally from socket 204. The distal ends of spring member 208 are attached to the cross-brace 206 and a rear section of the spring member is secured to socket 204. This general form of rake head construction, as thus far described is conventional and well known.

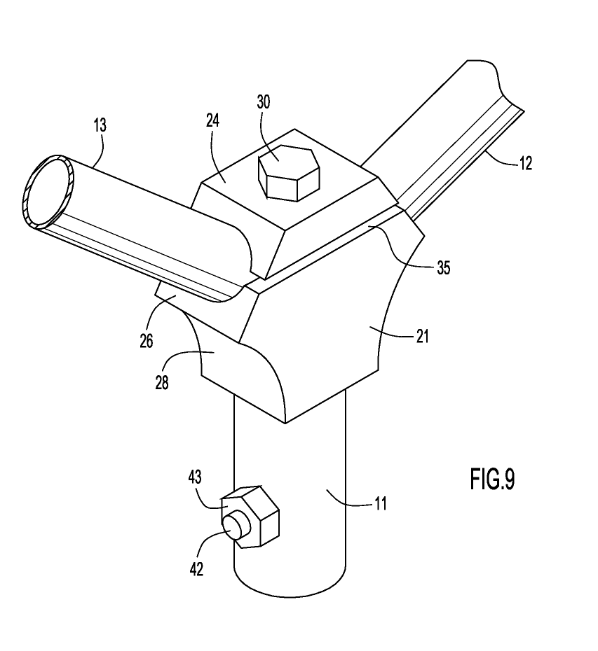

Joining member arms 119 and 120 are received in and secured to respective sockets 204 in rake heads 114 and 115. As best illustrated in FIG. 8, this engagement is achieved in the same general manner by which the distal end of handle 101 is secured in socket member 117. Specifically, an engagement screw extends through diametrically aligned apertures in the distal end of arms 119 (and 120) and in socket 204 and secured in place by a nut.

As employed in the present invention, the rake fingers 225 in each fan pattern of tines are coplanar and their distal tips, in their quiescent or unflexed state, are co-linear. The two rake heads are secured to their respective joining member arms such that the plane defined by rake fingers 225 in rake head 114 is coplanar with the plane defined by rake fingers in rake head 115. Likewise, the tips of the fingers in the two rake heads are co-linear when their tines are unflexed. The distal ends of the tine sections are bent to form rake fingers 225, the bend being nominally 90° but can be anywhere from 75° to 105° depending on the intended raking application.

As in most rake heads of the type employed herein, the spacing between adjacent rake fingers 125 is uniform in each rake head; that is, the spacing between adjacent fingers is the same throughout the length of the finger array. This permits for uniform raking strokes. An important aspect of the present invention is that rake heads 114 and 115 are positioned in side-by-side relation with the transversely innermost rake finger of rake head 114 positioned proximate the transversely innermost rake finger of rake head 115 such that the spacing between these innermost fingers is substantially the same as the spacing between fingers in the individual rake heads. This provides uniform spacing between adjacent rake fingers in the overall rake assembly and permits uniform raking strokes by all of the fingers across the doubled rake stroke swath.

The following list of parameters, materials and dimensions is provided by way of example only for one version of the embodiment illustrated in FIGS. 1-8 and should not be construed as limiting the scope of the invention except as recited in any one or more claims:
The handle 101 and the joining member (118, 119, 120) are steel tubes.
The tines are flat steel strips, preferably spring steel.
The length of handle 101 from the proximal end of grip 116 to distal the tip of distal end 125 is approximately fifty-four inches. The tube has a nominal outside diameter of 1¼ inch. These dimensions when combined with conventional rake heads and the dimensions of the joining member have proven to be somewhat optimal for raking sand traps.
The base portion 118 of the joining member is twenty-four inches long; the legs 119 and 120 are six and five-eighths inches long. The tube has a nominal outside diameter of approximately one inch.

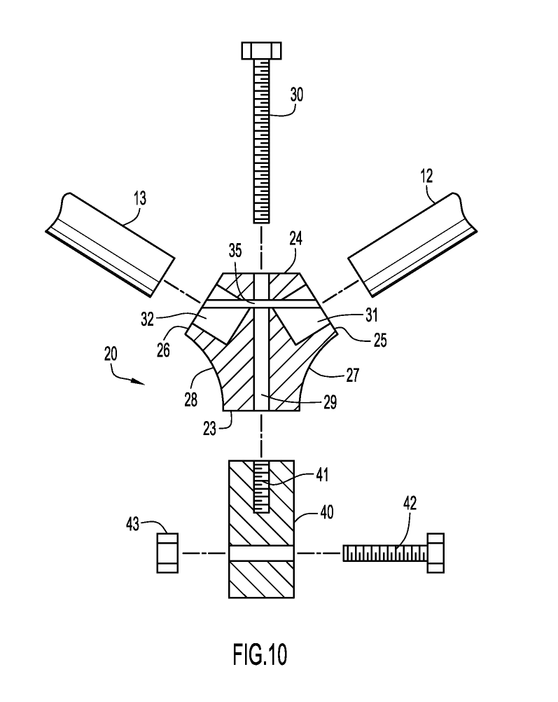

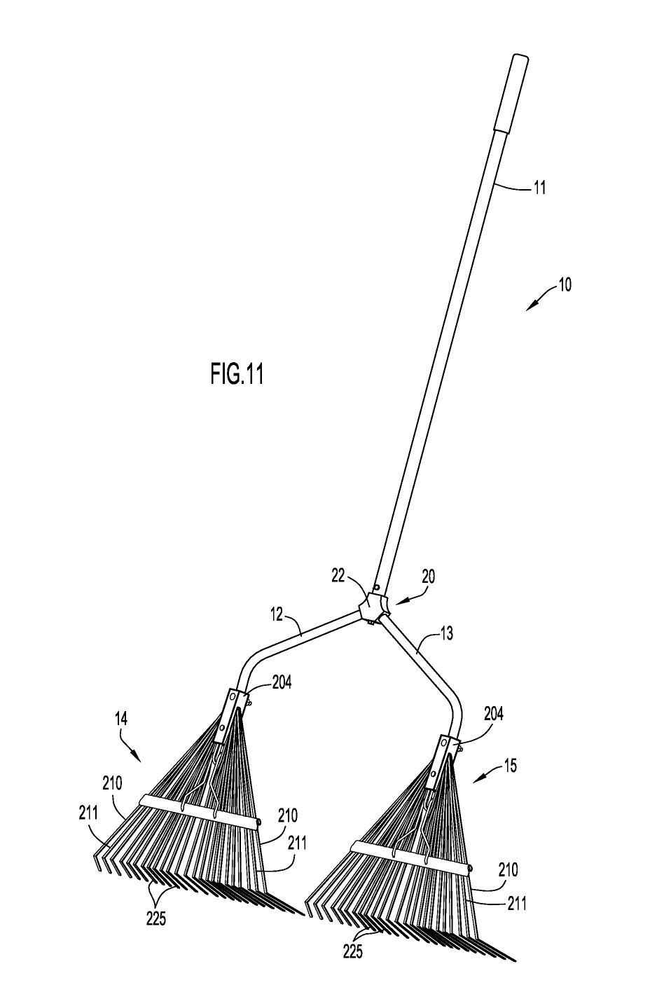

An alternative embodiment of the present invention is illustrated in FIGS. 9-11. Specifically, a common tubular rake handle 11 and tubular stems 12, 13 are joined at their proximal ends in an assembly 10 by a connector 20 from which the handle and stems extend in a generally Y-shaped configuration. In this embodiment the two rake stems 12, 13 are angularly spaced from one another about connector 20 by approximately 110° and from the common handle by approximately 135°. The rake stems 12, 13 have respective bends of approximately 55° at some point along their lengths so that at their distal points of connection to their respective rake heads 14, 15 they are substantially or approximately parallel to one another and to the common handle 11.

The rake heads 14, 15 are substantially identical and are of the same type described above for rake heads 114 and 115 in the embodiment of FIGS. 1-8. The coplanar positioning orientation and the spacing between the rake fingers is also as described for that embodiment.

A three way connector 20 permits the single rake handle to be removably but firmly connected to the two rake stems 12, 13 using a minimum of attachment connections and, in a preferred embodiment, using a single screw connection. The preferred embodiment of the connector takes the form of an octahedron having parallel front and back surfaces 21, 22, respectively, parallel top and bottom surfaces 23, 24, respectively, two lower side surfaces 25, 26, respectively, diverging upward from respective side edges of the bottom surface, and two upper side surfaces 27, 28, respectively, diverging downward from respective side edges of the top surface and terminating at a common edge with a respective lower side surface. In this preferred embodiment the upper side surfaces 27, 28 are arcuately concave to conserve mass and material; all of the other surfaces are preferably planar. A central longitudinal through bore 29 extends lengthwise between the centers of the top and bottom surfaces 23 and 24 and is preferably cylindrical and sized to permit an attachment screw 30 (described below) to extend axially through the body of connector 20.

Generally cylindrical blind bores 31, 32 are defined perpendicularly to a prescribed depth in respective lower side surfaces 25, 26 to slidably receive the proximal ends of respective rake stems 12, 13. The divergence angle between the lower side surfaces 25, 26 is selected to be equal to the desired divergence between to two rake stems.

A through channel 35 is defined in the front surface 21 between the lower side surfaces 25, 26 and in communication at its ends with respective blind bores 31, 32. The space defined by the through channel 35 permits the upper portion of the connector to be moved slightly toward the lower portion across the channel space in response to a predetermined axial force applied compressively between the top and bottom surfaces 23 and 24. As a consequence of this movement the distal ends of the rake stems 12, 13 disposed in the blind bores 31, 32 are tightly engaged for as long as the predetermined compressive force remains.

If the common rake handle 11 is a solid member it is provided at its lower end with a tapped hole configured to receive and threadedly engage the distal portion of an attachment screw extending axially through the entire central bore 29. Alternatively, if the common handle 11 is a hollow tube a solid cylindrical anchor 40 is inserted in the lower end of the handle and is provided with the tapped hole 41 to receive the attachment screw. In the latter embodiment the anchor 40 is prevented from moving distally into the tubular handle 11 by a limit screw 42 extending transversely through the handle and engaged by a nut 43 at a location longitudinally spaced appropriately from the handle lower end. In either embodiment, when the attachment screw 30 is inserted through the central bore 29 with its distal end engaged in the tapped hole 41, tightening of screw to the maximum extent forces the head of screw 30 against bottom surface 24 and the lower end of handle 11 (or anchor 40) against top surface 23. This secures the handle to the connector and applies a compressive force between the top and bottom surfaces of the connector. The compressive force compresses the through channel 35 to radially compress the blind bores 31, 32 about the received distal ends of the rake stems 12, 13. Thus, tightening of the single attachment screw secures the handle and both rake stems to the connector.

Connector 20 has a variety of uses in which three rods or tubes are required to be easily joined at a common connection and extend in different directions. Examples include:
Supports for mounting and supporting two flag sticks extending or poles extending in different directions;
Street lighting structures wherein two separate fixture posts extend in different directions;
Common supports for two basketball backboards facing opposite direction in a gymnasium or on a playground.

In addition to being either hollow tubes or solid rods, the rake stems may have cross-sections that are round or polygonal, regular or irregular (i.e., asymmetric about their axial centers) and may be different for each joined member.

Having described preferred embodiments of a new and improved rake assembly and a new and improved three-way connector, it is believed that other modifications, variations and changes will be suggested to those skilled in the art in view of the teachings set forth herein. It is therefore to be understood that all such variations, modifications and changes are believed to fall within the scope of the present inventions. Although specific terms are employed herein, they are used in a generic and descriptive sense only and not for purposes of limitation.

What is claimed is:

1. A hand rake assembly comprising:
an elongated handle in the form of a rod having proximal and distal handle ends;
first and second rake heads each comprised of a fan-like pattern of multiple flexible elongated tines having bent distal tine ends defining rake fingers oriented in respective first and second arrays of side-by-side coplanar rake fingers; and
a joining member securing the distal handle end to the rake units such that the rake heads are in co-planar side-by-side adjacency with said first and second arrays of rake fingers disposed in a common plane when all of said tines are unflexed.

2. The hand rake assembly of claim 1 wherein said joining member is a general U-shaped bar having a relatively long base and first and second relatively shorter legs extending from the base, wherein said base is secured to the distal handle end and each of said first and second legs has a distal leg end secured to said first and second rake heads, respectively.

3. The hand rake assembly of claim 2 wherein said joining member is secured two the distal handle end by means of a socket member adapted to receive and engage the distal handle end.

4. The hand rake assembly of claim 3 further comprising first and second triangular gussets disposed on respective opposite sides of said socket member and welded to both the socket member and the base of said joining member.

5. The hand rake assembly of claim 1 wherein each rake unit includes a rake stem having a distal stem end joined to the rake head, a proximal stem end and an intermediate stem portion, wherein the stem distal end is secured to the rake head and extends perpendicularly therefrom, and wherein the intermediate stem portion includes a bend in the range of approximately 45° and 60°; and
wherein said joining member comprises a generally Y-shaped connector secured to the distal end of the handle, and the proximal ends of the stems.

6. The hand rake assembly of claim 1 wherein each of said first and second series of side-by-side co-linear tips has a length of approximately twenty-four inches, and said linear tip array has a combined length of between approximately forty-eight and fifty inches.

7. The hand rake assembly of claim 1 wherein said handle has a length of approximately forty-eight inches and has a grip in the form of a sleeve covering the proximal handle end.

8. The hand rake assembly of claim 1 wherein said joining member and handles are substantially coplanar with said rake heads.

9. A hand rake assembly comprising:
an elongated handle in the form of a rod having proximal and distal handle ends; and
first and second rake heads each comprised of multiple elongated tines having distal tine ends defining rake fingers oriented in respective first and second arrays of side-by-side coplanar rake fingers;
wherein the distal handle end is secured to the rake units such that the rake heads are in co-planar side-by-side adjacency.

10. The hand rake assembly of claim 9 wherein said first and second arrays of rake fingers are disposed in a common plane.
